(19) United States
(12) Patent Application Publication
(10) Pub. No.: US 2015/0170446 A1
(43) Pub. Date: Jun. 18, 2015

(54) ACCESS TRACKING AND RESTRICTION

(71) Applicant: Microsoft Corporation, Redmond, WA (US)

(72) Inventors: Alexander Burba, Seattle, WA (US); Brandon T. Hunt, Redmond, WA (US); Frank R. Morrison, III, Seattle, WA (US)

(73) Assignee: Microsoft Corporation, Redmond, WA (US)

(21) Appl. No.: 14/104,989

(22) Filed: Dec. 12, 2013

(51) Int. Cl. G07C 9/00

(52) U.S. Cl. CPC G07C 9/00134

(57) ABSTRACT

Embodiments are disclosed that relate to monitoring and controlling access based upon data from an environmental sensor. For example, one embodiment provides a method including monitoring a use environment with an environmental sensor, determining an identity of a first person in the use environment via sensor data from the environmental sensor, receiving a request for presentation of a content item for which the first person has authorized access, and presenting the content item in response. The method further comprises detecting entry of a second person into the use environment, identifying the second person via the sensor data, determining based upon the identity and upon the access restriction that the second person does not have authorized access to the content item, and modifying presentation of the content item based upon determining that the second person does not have authorized access to the environment.

### BACKGROUND

Access controls are used in many different settings. For example, access controls may be applied to help reduce the chance that a version of a media content item intended for more mature consumers is not viewed by viewers younger than a threshold age. Such restrictions may take the form of ratings that are enforced at an entry to a theater, or an authentication process used to obtain access (e.g. logging into a via pay-per-view system) in a home environment.

Access controls also may be used in other settings. For example, a business or other institution may restrict access to premises, specific areas within the premises, specific items of business property (e.g. confidential documents), etc., by using identification cards (e.g. a radiofrequency in such a setting identification (RFID) card) or other identification methods. Such access controls may be applied in various levels of granularity. For example, access to buildings may be granted to large groups, while access to computers, computer-stored documents, etc. may be granted on an individual basis.

### SUMMARY

Embodiments are disclosed herein that relate to monitoring and controlling access based upon an identification of a person as determined via data from an environmental sensor. For example, one embodiment provides, on a computing device, a method of enforcing an access restriction for a content item. The method includes monitoring a use environment with an environmental sensor, determining an identity of a first person in the use environment via sensor data from the environmental sensor, receiving a request for presentation of a content item for which the first person has authorized access, and presenting the content item in response. The method further comprises detecting entry of a second person into the use environment, identifying the second person via the sensor data, determining based upon the identity and upon the access restriction that the second person does not have authorized access to the content item, and modifying presentation of the content item based upon determining that the second person does not have authorized access to the environment.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a first embodiment of a use environment.

FIG. 2 illustrates an enforcement of an access restriction in the use environment of FIG. 1.

FIG. 3 shows a flow diagram depicting a first example embodiment of a method for enforcing an access restriction.

FIG. 4 shows a second embodiment of a use environment.

FIG. 5 illustrates an example enforcement of an access restriction in the use environment of FIG. 4.

FIG. 6 shows a flow diagram depicting a second embodiment of a method for enforcing an access restriction.

FIG. 7 shows a third embodiment of a use environment.

FIG. 8 illustrates an example enforcement of an access restriction in the use environment of FIG. 7.

FIG. 9 shows a flow diagram depicting a third embodiment of a method for enforcing an access restriction.

FIG. 10 shows a fourth embodiment of a use environment, and illustrates an example of the observation and recording of data regarding an interaction of a first person with an object in the use environment.

FIG. 11 illustrates an example of the observation and recording of data regarding an interaction of a second person with the object of FIG. 10.

FIG. 12 shows an embodiment of a computing device.

### DETAILED DESCRIPTION

As mentioned above, various methods may be used to enforce access control, including but not limited to the use of personnel (e.g. movie ticket offices), computer authentication (e.g. passwords for accessing digital content), and sensor technology (e.g. RFID tags for employees). However, such methods generally involve preventing initial access to the content, such as by preventing a document from being opened, a computer from being accessed, or a building or room from being accessed.

However, many instances may arise where such access restrictions may be ineffective. For example, the use of a password to restrict access to a document may be effective in preventing people who do not know the password from opening the document, but will do nothing to prevent an unauthorized person from viewing the document over the shoulder of an authorized person. Likewise, the use of an age-based rating for a video game title may help to prevent a person below the recommended age from purchasing the title at a store that enforces the ratings, but will do nothing to prevent that person from viewing or playing the game if the person enters the room while another person is playing.

Thus, embodiments are disclosed herein that relate to controlling access based upon the identification of a person in a use environment via environmental sensors, and modifying the presentation of a content item based upon the determined presence. Embodiments are also disclosed that relate to maintaining records of people that access a content item so that more information is known on who has in fact accessed the item.

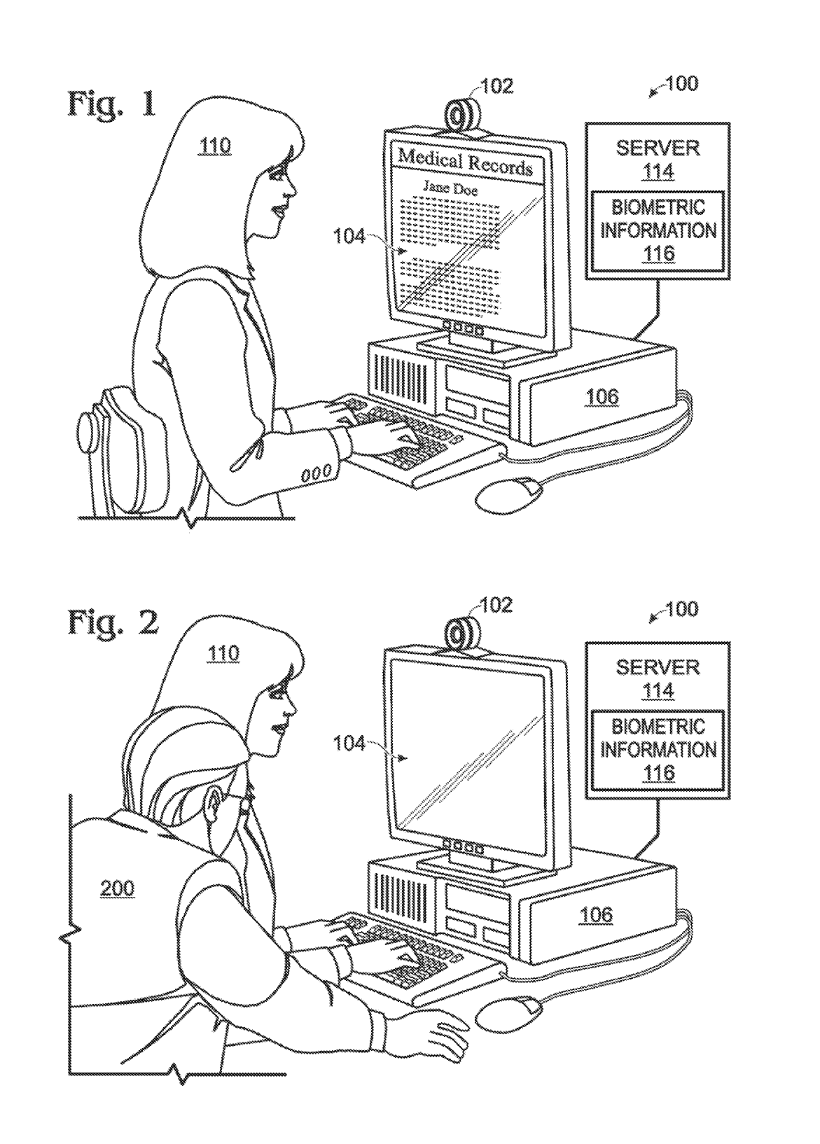

FIG. 1 shows an example use environment 100 that comprises an environmental sensor 102. The depicted environmental sensor 102 takes the form of an image sensor configured to image people within view of a document presented on a display 104 operatively connected to a computing device 106. While the environmental sensor 102 is depicted as being separate from the display 104, the sensor also may be incorporated into the computer monitor, or may have any other suitable location. Further, while depicted as a desktop computing device, it will be understood that the disclosed embodiments may be implemented on any suitable computing device. Examples include, but are not limited to, laptop computers, notepad computers, terminals, tablet computers, mobile devices (e.g. smart phones), wearable computing devices, etc.

The environmental sensor 102 may be configured to acquire any suitable type of image data. Examples include, but are not limited to, two-dimensional image data (e.g. visible RGB (color) image data, visible grayscale image data, and/or infrared data), and/or depth image data. Where the environmental sensor 102 utilizes depth sensor data, any suitable type of depth sensing technology may be used, including but not limited to time-of-flight and structured light depth sensing methods. Further, in some embodiments, two or more image sensors may be used to acquire stereo image data.

In FIG. 1, the computing device is displaying medical records (e.g. at a medical office) for a patient Jane Doe to a person 110 authorized to view the medical records, such as Jane Doe's doctor. As medical records may be considered highly sensitive and confidential, a list of persons authorized to view Jane Doe's medical records may be stored for the record, either with the record file or externally to the record file. People permitted to access the file may have previously provided biometric identification information (e.g. via a facial scan with a depth and/or 2 dimensional camera) to allow them to be identified with sensor data.

To help ensure that the information in the file is not seen by unauthorized persons, sensor data from the environmental sensor 102 may be used to identify people in the use environment by locating people in the image data, extracting biometric data regarding the people located, and then using the biometric information to identify the people located by comparing the biometric information to biometric information stored in digitally stored user profiles. Such analysis may be performed locally via computing device 106, or may be performed on a remote computing system, such as a server computing device 114 on which biometric information 116 for authorized users is stored, for a medical practice or other institution. Any suitable method may be used to extract such information from the image data, including but not limited to classifier functions, pattern matching methods, and other image analysis techniques.

Continuing with FIG. 1, as the person 110 viewing Jane Doe's medical records is her doctor, the computing device 106 permits display of the records via the display 104. However, referring to FIG. 2, if a person 200 that is not authorized to view Jane Doe's medical records enters the use environment, the computing device may detect the unauthorized person via sensor data from environmental sensor 102, and determine from biometric identification information extracted from the sensor data that the person is not authorized to access the medical records. If the person is not authorized, the computing device 106 may stop displaying the medical records, dim the display, switch to a private backlight mode (e.g. using a collimated backlight), or otherwise reduce the perceptibility of the medical records. Once person 200 leaves the use environment, the medical records may again be displayed. While described in the context of medical records, it will be understood that access to any other suitable type of computer-presented information may be restricted in this manner. Further, it will be understood that audio data received via a microphone may be used, alone or in combination with image data, to identify people in the use environment. Likewise, RFID or other proximity-based methods may be used to detect at least some unauthorized people (e.g. employees that are carrying an RFID badge but are not authorized to view the particular record being displayed).

FIG. 3 shows a flow diagram depicting an embodiment of a method 300 for restricting access to content. Method 300 may be performed on a computing device via execution of machine-readable instructions by logic hardware on the computing device. Method 300 comprises, at 302, monitoring a use environment with an environmental sensor. As mentioned above, any suitable environmental sensor or sensors may be used. For example, an environmental sensor may include image sensor(s) 304 configured to acquire two-dimensional and/or depth image data, and/or an acoustic sensor 306 (e.g. a microphone or microphone array) configured to acquire audio data. Further, other sensors may be alternatively or additionally used, such as a proximity tag reader 308 configured to read an RFID tag or other proximity-based device.

Method 300 further comprises, at 310, determining an identity of a first person in the use environment via sensor data, such as depth image data 312, voice data 314, and/or proximity data 316. The person may be identified in any suitable manner. For example, biometric information regarding the person's body (e.g. a depth scan of the person's face, a characteristic of the person's voice, etc.) may be compared to previously acquired data to determine the identity of the person. Likewise, identification information can also be obtained from reading information from a proximity card.

At 318, method 300 comprises receiving a user input requesting the presentation of a content item and determining that the first person has authorized access to the content item. For example, the identity of the first person as determined from the sensor data may be compared to a list of authorized people associated with the content item, and access may be granted only if the person is on the list. Method 300 further comprises, at 320, presenting the content item in response to determining that the first user is authorized to access the content item. The content item may be presented on a display device, such as a computer display 322 (e.g. a laptop or desktop monitor), a larger format display such as a meeting facility presentation screen 324 (e.g. a large format television, projector screen, etc.), or on any other suitable display device. Further, the content item also may be presented via audio output, as indicated at 326.

Continuing, method 300 comprises, at 328, detecting entry of a second person into the use environment via the sensor data, and at 330 identifying the second person from biometric information extracted from the sensor data. As described above, the second person may be identified via biometric data extracted from image data and/or audio data acquired by one or more environmental sensor, by RFID or other proximity sensor, and/or in any other suitable manner. If it is determined that the second person is authorized to access the content item, then no action may be taken in response (not shown in FIG. 3).

On the other hand, if it is determined that the second person does not have authorized access to the content item, as indicated at 332, then method 300 may comprise, at 340, modifying presentation of the content item based upon determining that the second person does not have authorize access to the content item. As described above, various situations may exist in which a person may not have authorized access to a content item. As non-limiting examples, a person may not be on a list of authorized viewers associated with the content item, as indicated at 334. Likewise, a person may not be on a computer-accessible meeting invitee list for a meeting in which access-restricted content is being presented, as indicated at 336. Further, a person may not be a professional or patent/client permitted to view a private, sensitive record (e.g. a medical record), as indicated at 338.

The presentation of the content item may be modified in any suitable manner based upon the determination that the second person does not have authorized access to the content item. For example, as indicated at 342, a visibility of the display image may be reduced (e.g. the output of the display image may be ceased, paused, dimmed, or otherwise obfuscated) Likewise, as indicated at 344, a perceptibility of an audio output may be reduced. Thus, in this manner, access controls may be automatically enforced during the actual presentation of a content item based upon the detected presence of an unauthorized person in the use enforcement.

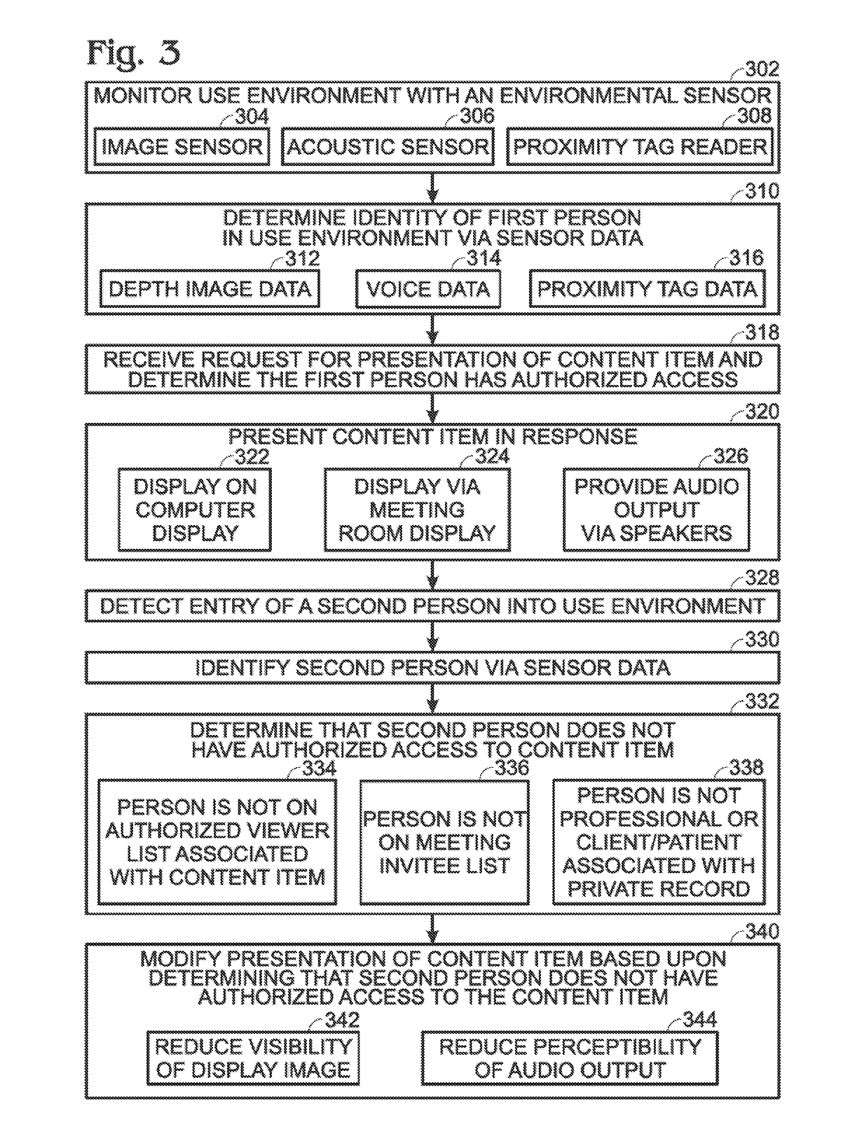

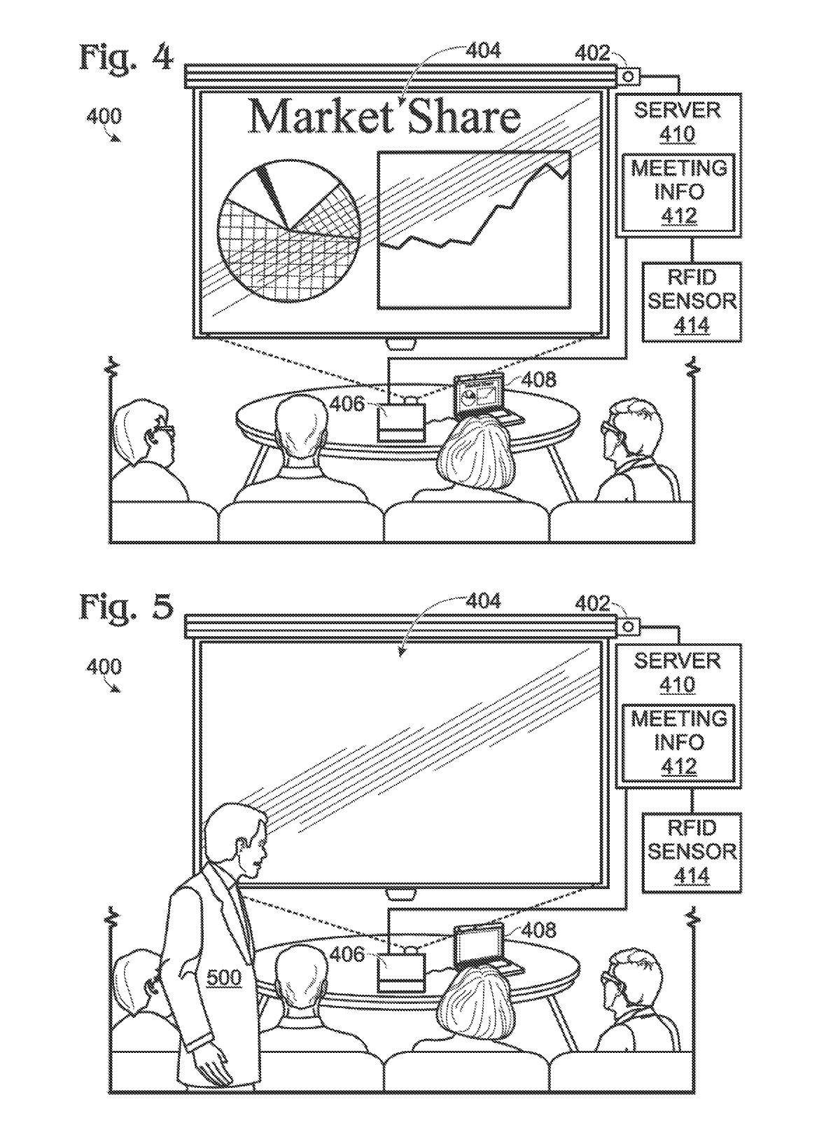

FIGS. 4 and 5 illustrate another example implementation of method 300 in the context of a meeting room environment 400. First, FIG. 4 shows an environmental sensor 402 observing a use environment in which a plurality of people are watching a presentation displayed on a projection screen 404 via a projector 406. A laptop computer 408 is shown as being operatively connected to the projector 406 to provide a content item to the projector 406 for display.

The environmental sensor 402 is operatively connected with a server 410 that also has access to meeting schedule information for one or more meeting rooms (e.g. for all meeting rooms in an enterprise), such that the server 410 can determine the invitees for each meeting on the schedule. Thus, during each meeting, the server 410 may receive data from the environmental sensor 402, locate people in the environment via the data, extract biometric information from the sensor data regarding each person located, and identify the people by matching the biometric data to previously acquired biometric data for each authorized attendee. RFID sensor data, as received via an RFID sensor 414, also may be used to detect entry of the uninvited person 500. While depicted as being performed on a server computing device, it will be understood that, in some embodiments, such receipt and processing of sensor data also may be performed on laptop computer 408, and/or via any other suitable computing device.

The server 410 is also operatively connected with the projector 406. Thus, if a person that is not on the invitee list enters the meeting room, as indicated by person 500 in FIG. 5, the server 410 may control the projector 404 to reduce the visibility of the presentation, for example, by dimming the projector, replacing the displayed private image with a non-private image, etc. Further, the server 410 also may be in communication with the laptop computer 408. Thus, the server 410 also may interact with the laptop computer 408 to control the presentation, for example, by instructing the laptop computer to cease display of the presentation (and/or cease an audio presentation) while the uninvited person 500 is in the meeting room. Once the uninvited person is determined from the sensor data to have left the meeting room, display of the presentation (and/or an audio presentation) may resume.

As yet another example, a whiteboard in a meeting room may be configured to be selectively and controllably turned darker (e.g. via use of variable tint glass), or otherwise changed in appearance. In such embodiments, when an uninvited person is detected entering the use environment, or otherwise detected inside of the use environment, the screen may be darkened until the person has left.

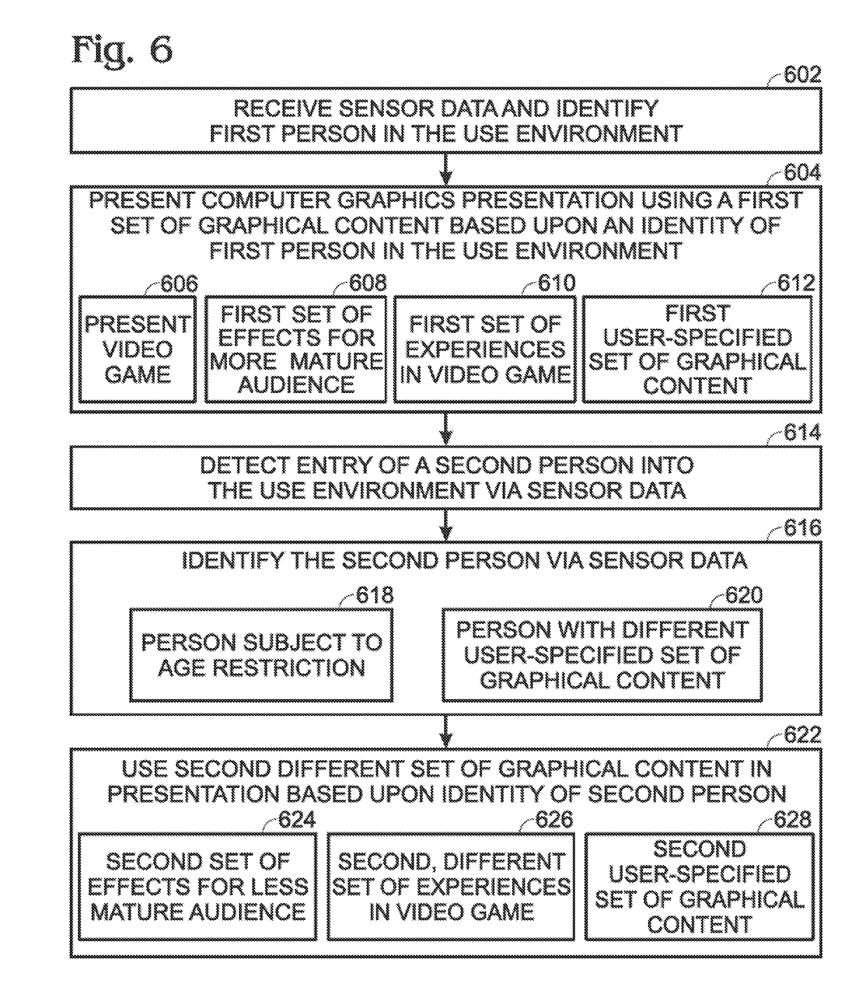

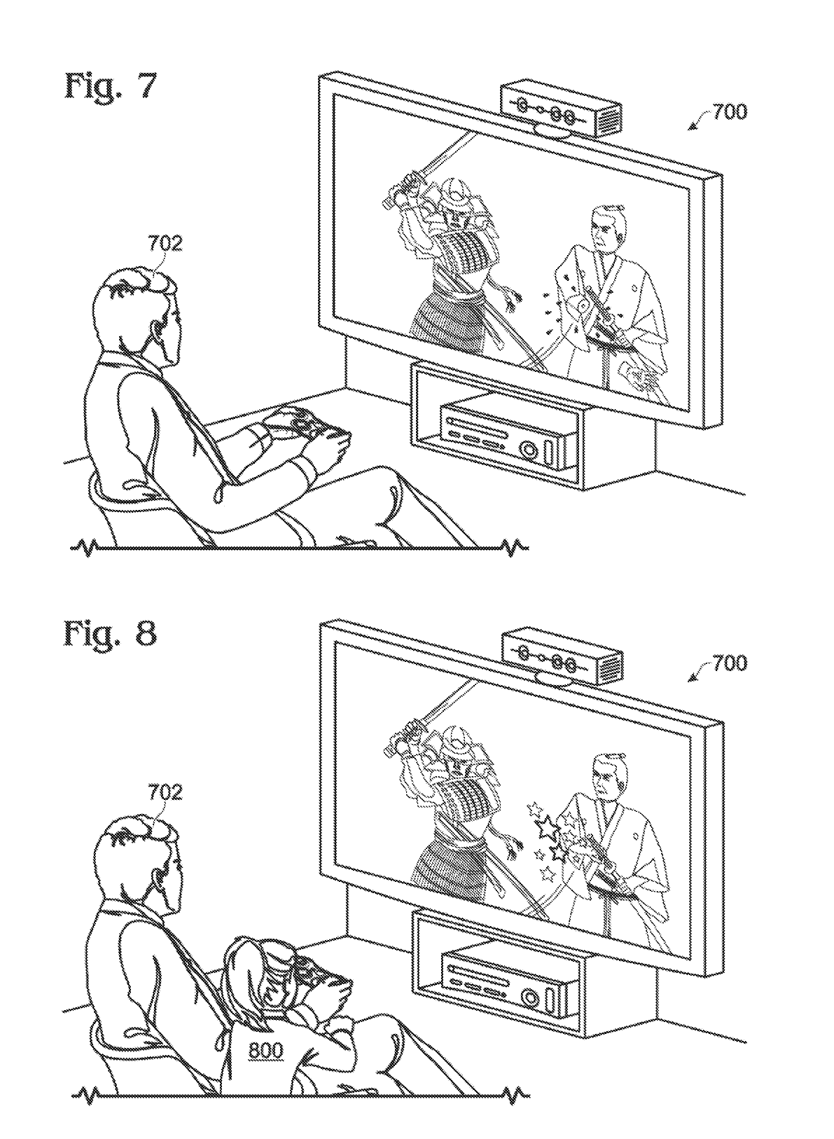

In addition to reducing the perceptibility of content, the application of access controls as disclosed herein also may be used to alter content being presented based upon who is viewing the content. FIG. 6 illustrates an embodiment of a method 600 for altering content based upon who is viewing the content. Method 600 comprises, at 602, receiving sensor data from an environmental sensor and identifying a first person in the environment, as described above. Method 600 further comprises, at 604, presenting a computer graphics presentation using a first set of graphical content based upon a first person in the use environment. As one non-limiting example, the computer graphics presentation may comprise a video game, as illustrated at 606. In such an example, the first set of graphical content may include a first set of rendered effects for a more mature audience, as indicated at 608. An example of such a set of effects is illustrated in FIG. 7, which shows a presentation 700 of a video game to a first user 702. In the presentation 700, an injury to a character in the video game is accompanied by realistic blood effects, along with a more graphical depiction of the injury (e.g. character's hand being cut off).

As another example, a first set of graphical content may include a first set of experiences in the video game, as indicated at 610. For example, a role-playing fantasy game may have less frightening levels that occur in open, above-ground settings, and more frightening levels that take place in darker, more frightening settings, such as dungeons, caves, etc. In such a game, the less frightening levels may be appropriate for younger players, while the more frightening levels may not be appropriate for such players. As such, the first set of experiences in the video game may comprise both the more frightening levels and less frightening levels, and a second set (described below) may include the less frightening levels but not the more frightening levels.

As yet another example, the first set of graphical content may correspond to a first user-specified set of graphical content. In some instances different users may wish to view different experiences while playing. Thus, a user may specify (e.g. by user profile) settings regarding what content will be rendered during play of the video game (e.g. more blood or less blood when characters are injured), and/or any other suitable settings.

Continuing, method 600 further comprises, at 614, detecting a second person in the use environment via the sensor data, and at 616, identifying the person via the sensor data. In some instances, the person identified may be determined to be subject to an age restriction (e.g. too young to view a particular set of graphical content in a video game), as indicated at 618 and illustrated in FIG. 8 by a child entering the use environment. The person also may have specified a preference to view the computer graphics content rendered with a different set of graphical content than the set currently being used to render the content, as indicated at 620. Further, other characteristics of identified persons may trigger the modification of the presentation of the computer graphics than those described above.

Method 600 further comprises, at 622, using a second, different set of graphical content to render the presentation based upon the identity of the second person. The second, different set of graphical content may comprise any suitable content. For example, the second set of content may comprise a second set of effects intended for a less mature audience, as indicated at 624. Referring again to FIG. 8, upon the detected entry of the child 800 into the use environment, a different set graphical content for rendering the injury effects is illustrated as stars rendered in the video game presentation 700 in place of the blood effects, potentially accompanied by a less graphic depiction of the injury (e.g. the missing hand is again displayed on the character's arm).

As another example, as indicated at 626, a second, different set of experiences in the video game may be provided in response to detecting and identifying the second person. For example, if the second person is a child, then more frightening parts of a video game may be locked while the child is present. Additionally, as indicated at 628, a second user-specified set of graphical content may be used to render and display the computer graphics content based upon the detected presence of the second person. It will be understood that these specific modifications that may be made to a computer graphics presentation are described for the purpose of example and are not intended to be limiting in any manner.

Further, in some instances, content settings may be defined for groups of viewers, as opposed to or in addition to for individual viewers, such that a different set of graphical content is used for different groups of family members. Further, where multiple users each with different user-set preferences are identified in a use environment, a set of graphical content to use to render a computer graphics presentation may be selected in any suitable manner, such as by selecting a set based upon a most restrictive setting of the group for each category of settings (e.g. blood level, violence level, etc.).

Access control methods as described herein also may be used to record information regarding who accesses content. For example, in the embodiment of FIGS. 1-2, each person that enters a use environment in which access-restricted content is displayed may be identified, and the identification of the person and time of access may be stored. This may allow the identities of authorized viewers that viewed a content item to be reviewed at a later time, and also may help to determine whether any unauthorized people may have viewed the content item, so that confidentiality may be maintained.

In some embodiments, face and/or eye tracking techniques may be used to obtain more detailed information about who has viewed or may have viewed a content item. For example, eye tracking may be used to determine which part of a content item may have been viewed (e.g. which page of a document). Further, steps may be taken to ensure that the unauthorized people that may have viewed the content are notified of an obligation of confidentiality. This may help to preserve trade secrets, lessen liability risks arising from inadvertent disclosures of private information, and/or provide other such benefits.

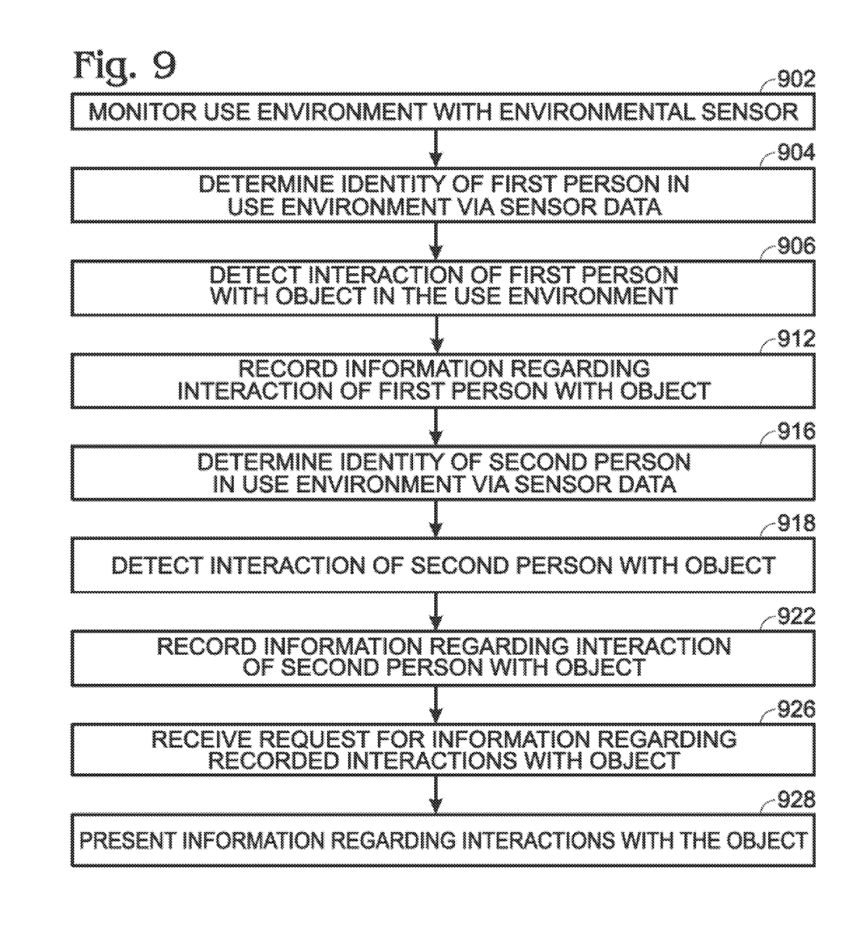

Likewise, the embodiments disclosed herein also may track people that interact with an object (e.g. a device under construction, a device that undergoes periodic maintenance, etc.) so that logs may be maintained regarding who interacted with the object. FIG. 9 shows a flow diagram depicting an embodiment of a method 900 of recording interactions of people with objects. Method 900 comprises, at 902, monitoring a use environment with environmental sensor, as described above, and at 904, determining an identity of a first person in the use environment via the sensor data. Method 900 further comprises, at 906, detecting an interaction of the first person with the object in the use environment. As one non-limiting example, the interaction may comprise a first assembly step of an object being assembled, wherein the term “first assembly step” is not intended signify any particular location of the step in an overall object assembly process. Likewise, the interaction may comprise an interaction with an object under repair or maintenance.

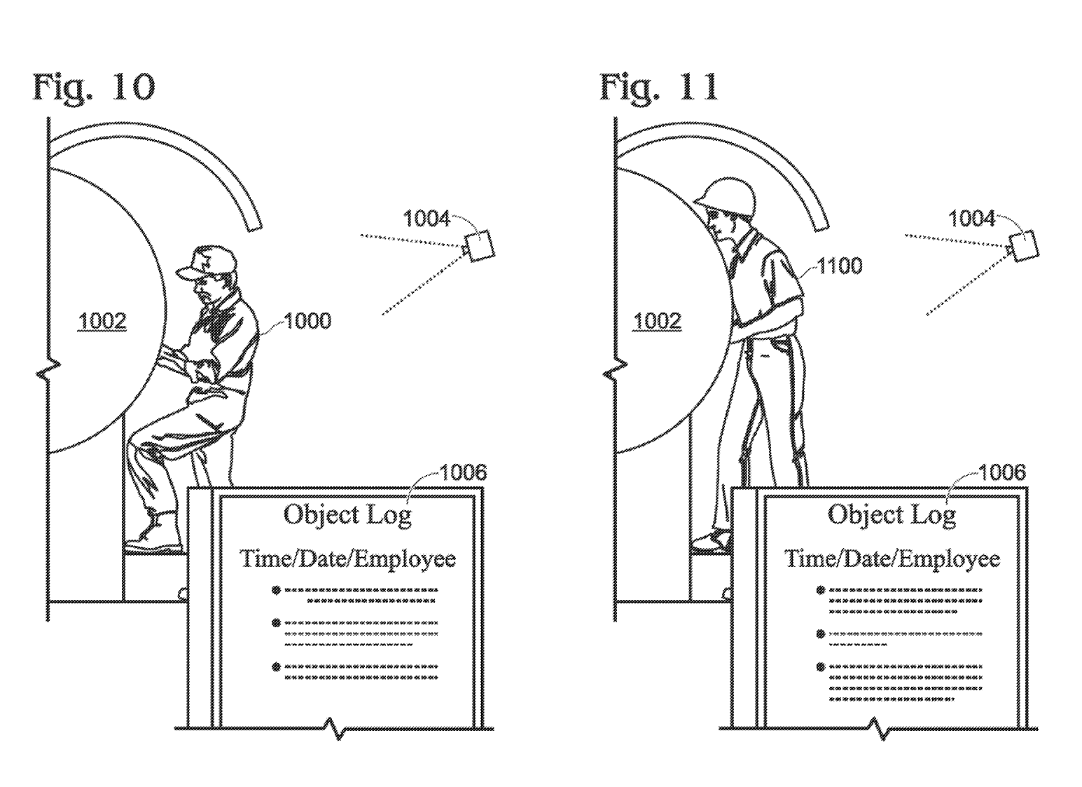

Method 900 further comprises, at 912, recording information regarding the interaction of the first person with the object. For example, information may be recorded regarding the person's identity, the object's identity, a time of interaction, a type of interaction (e.g. as determined via gesture analysis), a tool used during the interaction (e.g. as determined from object identification methods), and/or any other suitable information. FIG. 10 illustrates an example embodiment in which a first person 1000 is working on a large object 1002 such as an engine while an environmental sensor 1004 is acquiring data during the interaction with the object. FIG. 10 also schematically illustrates a record 1006 of the interaction stored via a computing system (not shown) to which sensor 1004 is operatively connected.

Continuing with FIG. 9, method 900 comprises, at 916, determining an identity of a second person in the use environment via the sensor data, and detecting, at 918, an interaction of a second person with the object. For example, the second interaction may be a second assembly step of an object being assembled, a second maintenance interaction with an object being maintained, or any other suitable interaction. Method 900 further comprises, at 922, recording information regarding the interaction of the second person with the object. An example of this is shown in FIG. 11, where a second person 1100 accesses object 1002 of FIG. 10, and information about the interaction is recorded.

Next, method 900 comprises, at 926, receiving a request for information regarding recorded interactions with the object. For example, the request may comprise a request for a maintenance history regarding the object (e.g. to see what procedures were performed, when they were performed, and by whom they were performed), for information regarding an assembly process for the object (e.g. to determine who performed each step of the assembly process and when each step was performed), for or other suitable information. Further, information also may be viewed on a person-by-person basis, rather than an object-by-object basis, for example to track productivity of an individual. In response to the request, method 900 comprises, at 928, presenting (e.g. via a computing device) the information requested.

The embodiments described herein may be used in other environments and manners than the examples described above. For example, if it is determined from sensor data that a person has left his or her desk or workplace while a sensitive content item is open on a computing device, the computing device may dim the display, close the document, automatically log the user out, and/or take other steps to prevent others from viewing the content item. In one such embodiment, an RFID sensor may be located at the computing device to determine when the use is proximate the computing device, while in other embodiments one or more image sensors and/or other environmental sensors (image, acoustic, etc.) may be used. Additionally, eye tracking may be employed, for example, to track a specific page or even portion of a page at which a user is gazing.

In some embodiments, the methods and processes described herein may be tied to a computing system of one or more computing devices. In particular, such methods and processes may be implemented as a computer-application program or service, an application-programming interface (API), a library, and/or other computer-program product.

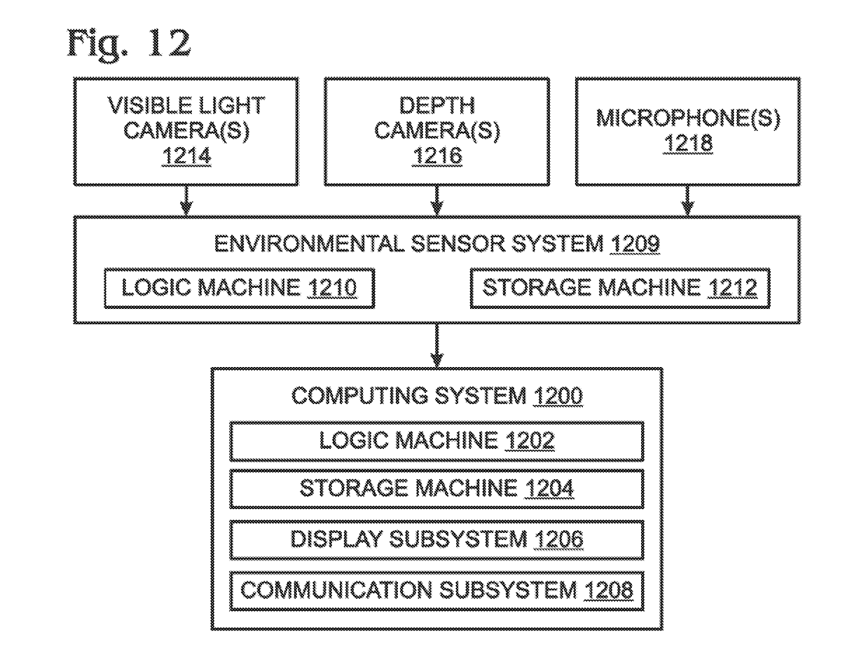

FIG. 12 schematically shows a non-limiting embodiment of a computing system 1200 that can enact one or more of the methods and processes described above. Computing system 1200 is shown in simplified form. Computing system 1200 may take the form of one or more personal computers, server computers, tablet computers, home-entertainment computers, network computing devices, gaming devices, mobile computing devices, mobile communication devices (e.g., smart phone), and/or other computing devices.

Computing system 1200 includes a logic machine 1202 and a storage machine 1204. Computing system 1200 may optionally include a display subsystem 1206, a communication subsystem 1208, and/or other components not shown in FIG. 12.

Logic machine 1202 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage machine 1204 includes one or more physical devices configured to hold instructions executable by the logic machine to implement the methods and processes described herein. When such methods and processes are implemented, the state of storage machine 1204 may be transformed—e.g., to hold different data.

Storage machine 1204 may include removable and/or built-in devices. Storage machine 1204 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 1204 may include volatile, nonvolatile, dynamic, static, read/write, read-only, random-access, sequential-access, location-addressable, file-addressable, and/or content-addressable devices.

It will be appreciated that storage machine 1204 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 1202 and storage machine 1204 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 1200 implemented to perform a particular function. In some cases, a module, program, or engine may be instantiated via logic machine 1202 executing instructions held by storage machine 1204. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 1206 may be used to present a visual representation of data held by storage machine 1204. This visual representation may take the form of a graphical user interface (GUI). As the herein described methods and processes change the data held by the storage machine, and thus transform the state of the storage machine, the state of display subsystem 1206 may likewise be transformed to visually represent changes in the underlying data. Display subsystem 1206 may include one or more display devices utilizing virtually any type of technology. Such display devices may be combined with logic machine 1202 and/or storage machine 1204 in a shared enclosure, or such display devices may be peripheral display devices.

When included, communication subsystem 1208 may be configured to communicatively couple computing system 1200 with one or more other computing devices. Communication subsystem 1208 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 1200 to send and/or receive messages to and/or from other devices via a network such as the Internet.

Computing system 1200 may be configured to receive input from an environmental sensor system 1209, as described above. To this end, the environmental sensor system includes a logic machine 1210 and a storage machine 1212. The environmental sensor system 1209 may be configured to receive low-level input (i.e., signal) from an array of sensory components, which may include one or more visible light cameras 1214, depth cameras 1216, and microphones 1218. Other example sensors that may be used may include one or more infrared or stereoscopic cameras; a head tracker, eye tracker, accelerometer, and/or gyroscope for motion detection and/or intent recognition; as well as electric-field sensing componentry for assessing brain activity. In some embodiments, the sensor system interface system may comprise or interface with one or more user-input devices such as a keyboard, mouse, touch screen, or game controller.

The environmental sensor system 1209 processes the low-level input from the sensory components to yield an actionable, high-level input to computing system 1200. Such action may, for example, generate biometric information for the identification of people in a use environment, and/or generate corresponding text-based user input or other high-level commands, which are received in computing system 1200. In some embodiments, the environmental sensor system interface system and sensory componentry may be integrated together, at least in part. In other embodiments, the environmental interface system may be integrated with the computing system and receive low-level input from peripheral sensory components.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. On a computing device, a method of enforcing access restriction information for a content item, the method comprising:
monitoring a use environment with an environmental sensor;
determining an identity of a first person in the use environment via sensor data from the environmental sensor;
receiving a request for presentation of a content item for which the first person has authorized access and presenting the content item in response;
detecting entry of a second person into the use environment and identifying the second person via the sensor data;
determining based upon the identity and upon the access restriction information that the second person does not have authorized access to the content item; and
modifying presentation of the content item based upon determining that the second person does not have authorized access to the content item.

2. The method of claim 1, wherein the environmental sensor comprises a depth camera, and wherein determining the identities of the first person and second person comprises determining the identities via biometric information obtained from depth image data.

3. The method of claim 1, wherein the environmental sensor comprises a microphone, and wherein determining the identity of the first person comprises determining the identities via voice information received with the microphone.

4. The method of claim 1, wherein modifying presentation of the content item comprises reducing a perceptibility of the content item as displayed on a display device.

5. The method of claim 1, wherein modifying presentation of the output of the content item comprises reducing a perceptibility of an audio output of the content item.

6. The method of claim 1, wherein the use environment is a meeting facility, wherein the first person is determined from sensor data to be an authorized attendee of a meeting, and wherein the second person is determined from the sensor data not to be an authorized attendee of the meeting.

7. The method of claim 1, wherein the use environment is a medical office, wherein the content item comprises a medical record, and wherein the second person is a person other than a doctor and a patient associated with the medical record.

8. The method of claim 1, wherein the environmental sensor comprises a proximity tag reader, and wherein determining that the second person does not have authorized access to the content item comprises reading a proximity tag of the second person as the second person enters the use environment.

9. A computing system, comprising:
a logic machine; and
a storage machine comprising instructions that are executable by the logic machine to
receive sensor data from an environmental sensor;
present a computer graphics presentation using a first set of graphical content based upon an identity of a first person in the use environment as determined from the sensor data;
detect entry of a second person into the use environment and identify the second person via the sensor data; and
change the computer graphics presentation to use a second, different set of graphical content based upon an identity of the second person.

10. The computing system of claim 9, wherein the first set of graphical content comprises a set of graphical content intended for a more mature audience, and wherein the second set of graphical content comprises a set of graphical content intended for a less mature audience.

11. The computing system of claim 10, wherein the first set of graphical content comprises a more realistic depiction of an effect of an injury to a character in the computer graphics presentation, and wherein the second set of graphical content comprises a less realistic depiction of an effect of an injury.

12. The computing system of claim 9, wherein the first set of graphical content comprises a first set of experiences in the computer graphics presentation, and wherein the second set of graphical content comprises a second, smaller set of experiences in the computer graphics presentation.

13. The computing system of claim 9, wherein the second set of graphical content comprises a user-specified set of graphical content.

14. The computing system of claim 9, wherein the instructions are further executable to detect that the second person has left the room, and in response presenting the computer graphics presentation with the first set of graphical content.

15. The computing system of claim 9, wherein the computer graphics presentation comprises a video game.

16. On a computing device, a method of obtaining information regarding interactions of people with objects, the method comprising:
monitoring a use environment with an environmental sensor;
determining an identity of a first person in the use environment via sensor data from the environmental sensor;
detecting an interaction of the first person with an object in the use environment;
recording information regarding the interaction of the first person with the object;
determining an identity of a second person in the use environment via sensor data from the environmental sensor;
detecting an interaction of the second person with the object in the use environment;
recording information regarding the interaction of the second person with the object in the use environment;
receiving a request for presentation of information regarding recorded interactions with the object; and
presenting the information regarding the interaction of the first person with the object and the interaction of a second person with the object.

17. The method of claim 16, wherein the object is an object being assembled, wherein the interaction of the first person with the object comprises a first assembly step, and wherein the interaction of the second person with the object comprises a second assembly step.

18. The method of claim 17, further comprising recording each interaction of the first person with a plurality of objects under assembly, and recording each interaction of the second person with a plurality of objects under assembly.

19. The method of claim 18, wherein presenting the information regarding the interaction of the first person with the plurality of object under an assembly comprises presenting productivity information.

20. The method of claim 18, wherein the object is a restricted access object, and wherein presenting the information comprises presenting information regarding people that have accessed the restricted access object.
